(19) United States
(12) Patent Application Publication
(10) Pub. No.: US 2026/0005726 A1
(43) Pub. Date: Jan. 1, 2026

(54) Systems and Methods for Dynamic Antenna Tuning of an RFID-Integrated Indicia-Reading Device

(71) Applicant: ZEBRA TECHNOLOGIES CORPORATON, Lincolnshire, IL (US)

(72) Inventors: Damien Ramrattan, Coram, NY (US); Christopher P. Klicpera, Westbury, NY (US); Rehan K. Jaffri, Tarrytown, NY (US)

(21) Appl. No.: 18/759,736

(22) Filed: Jun. 28, 2024

(51) Int. Cl. H04B 5/77; G06K 7/10; H01Q 1/22

(52) U.S. Cl. CPC H04B 5/77; G06K 7/10316; H01Q 1/2216

(57) ABSTRACT

Systems, devices, and methods for dynamic antenna tuning are provided herein. The method determines an operating mode of a device from first and second modes. The device comprises an antenna having a target impedance that changes based on the operating mode of the device. The method, responsive to determining the operating mode of the device is the first mode, utilizes a first circuit to drive a first impedance of the antenna associated with the first mode to the target impedance to operate the antenna at a predetermined power level in a first frequency bandwidth and a predetermined range. The method, responsive to determining the operating mode of the device is the second mode, utilizes a second circuit to drive a second impedance of the antenna associated with the second mode to the target impedance to operate the antenna at the predetermined power level in the first frequency bandwidth and the predetermined range.

### BACKGROUND

An indicia and/or tag reading device (e.g., a barcode reader and/or a radio frequency identification (RFID) reader) is utilized to read barcodes and/or RFID tags that are affixed to objects to register pricing, track inventory, and a variety of other purposes. An indicia and/or tag reading device must often adhere to design requirements such that the device has a compact and ergonomically user-friendly form factor. In view of space constraints within a housing of a device that integrates barcode reading and RFID functionality and performance expectations of the device, it can be challenging for the device to adhere to these design requirements without yielding to a large and bulky form factor and/or performance degradation.

### SUMMARY

In an embodiment, the present invention is a method for dynamically tuning an antenna. The method determines an operating mode of a device from a first mode indicative of a presentation mode and a second mode indicative of a handheld mode. The device comprises an antenna having a target impedance that matches an impedance of a transceiver coupled to the antenna to provide maximum power transfer to the antenna and operate the antenna at a predetermined power level and a predetermined range. The target impedance changes based on the operating mode of the device. Responsive to determining the operating mode of the device is the first mode, the method utilizes a first circuit to drive a first impedance of the antenna associated with the first mode to the target impedance to operate the antenna at the predetermined power level in a first frequency bandwidth and the predetermined range. Responsive to determining the operating mode of the device is the second mode, the method utilizes a second circuit to drive a second impedance of the antenna associated with the second mode and different from the first impedance to the target impedance to operate the antenna at the predetermined power level in the first frequency bandwidth and the predetermined range.

In another embodiment, the present invention is a device comprising an antenna and a controller. The antenna has a target impedance that matches an impedance of a transceiver coupled to the antenna to provide maximum power transfer to the antenna and operate the antenna at a predetermined power level and a predetermined range. The target impedance changes based on an operating mode of the device. The controller is configured to: responsive to determining the operating mode of the device is the first mode, control a first circuit to drive a first impedance of the antenna associated with the first mode to the target impedance to operate the antenna at the predetermined power level in a first frequency bandwidth and the predetermined range; and responsive to determining the operating mode of the device is the second mode, control a second circuit to drive a second impedance of the antenna associated with the second mode and different from the first impedance to the target impedance to operate the antenna at the predetermined power level in the first frequency bandwidth and the predetermined range.

In another embodiment, the present invention is a system for dynamically tuning an antenna. The system comprises an antenna, a first switch, a second switch and a controller. The antenna has a target impedance that matches an impedance of a transceiver coupled to the antenna to provide maximum power transfer to the antenna and operate the antenna at a predetermined power level and a predetermined range. The target impedance changes based on an operating mode of the device. The controller is configured to: determine an operating mode of the device from a first mode indicative of a presentation mode and a second mode indicative of a handheld mode; responsive to determining the operating mode of the device is the first mode, activate the first and second switches to a first position to control a first circuit to drive a first impedance of the antenna associated with the first mode to the target impedance to operate the antenna at the predetermined power level in a first frequency bandwidth and the predetermined range; and responsive to determining the operating mode of the device is the second mode, activate the first and second switches to a second position to control a second circuit to drive a second impedance of the antenna associated with the second mode and different from the first impedance to the target impedance to operate the antenna at the predetermined power level in the first frequency bandwidth and the predetermined range.

In another embodiment, the present invention is a system for dynamically tuning an antenna. The system comprises an antenna, at least one tuning component, at least one switch, and a controller. The antenna has a target impedance that matches an impedance of a transceiver coupled to the antenna to provide maximum power transfer to the antenna and operate the antenna at a predetermined power level and a predetermined range. The target impedance changes based on an operating mode of the device. The controller is configured to: determine an operating mode of the device from a first mode indicative of a presentation mode and a second mode indicative of a handheld mode; responsive to determining the operating mode of the device is the first mode, activate the at least one switch to a first position to exclude the at least one tuning component and/or include the at least one tuning component to drive a first impedance of the antenna associated with the first mode to the target impedance to operate the antenna at the predetermined power level in a first frequency bandwidth and the predetermined range; and responsive to determining the operating mode of the device is the second mode, activate the at least one switch to a second position to include the previously excluded at least one tuning component and/or exclude the previously included at least one tuning component to drive a second impedance of the antenna associated with the second mode and different from the first impedance to the target impedance to operate the antenna at the predetermined power level in the first frequency bandwidth and the predetermined range.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram illustrating an embodiment of the present disclosure.

FIGS. 2A-B are diagrams illustrating example modes of the device of FIG. 1.

FIG. 3 is a flowchart illustrating processing steps of an embodiment of the present disclosure.

FIG. 4 is a flowchart illustrating processing steps of another embodiment of the present disclosure.

FIG. 5 is a diagram illustrating the processing steps of FIG. 4.

FIG. 6 is a flowchart illustrating processing steps of another embodiment of the present disclosure.

FIG. 7 is a diagram illustrating the processing steps of FIG. 6.

FIG. 8 is a diagram illustrating the processing steps of FIG. 6.

FIG. 9 is a diagram illustrating the processing steps of FIG. 6.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

As mentioned above, in view of space constraints within a housing of a device that integrates barcode reading and RFID functionality and performance expectations of the device, it can be challenging for the device to adhere to design requirements that yield a compact and ergonomically user-friendly device. For example, to adhere to these design requirements, one or more antennas (e.g., Bluetooth®, WiFi®, and/or RFID) may be positioned in an upper portion (e.g., a head or canopy) of a device. The one more antennas generally share the upper portion of the device with a user interface (UI), one or more opto-mechanical assemblies (e.g., a scanning assembly), and/or one more sensors (e.g., an accelerometer, a reed switch, a hall effect sensor, a capacitive touch sensor, an optical sensor, a gyroscope, and/or any suitable sensor or combination of sensors). This can result in inefficient antenna design and inadequate antenna to antenna isolation which may degrade antenna performance.

Additionally, an RFID antenna generally requires positioning within an area of a device housing sufficiently spacious to accommodate a large size of the RFID antenna for efficient performance, and the RFID antenna can be sensitive to the presence of metallic and/or lossy material associated with opto-mechanical assemblies, batteries, and sensors. Therefore, an RFID antenna is generally positioned externally to the unit in a “foot” at the bottom of the device or a “chin” below and in front of an exit window of a device (e.g., a barcode scanner) sufficiently spacious to accommodate the large size of the RFID antenna for efficient performance and sufficiently separate from the metallic and/or lossy components of the device to avoid interference from these components which may degrade RFID antenna performance. However, the positioning of an RFID antenna in the foot or chin of a device may exceed design specifications for RFID-integrated devices that have compact (e.g., size and weight) and ergonomically user-friendly requirements.

In another example, to adhere to these design requirements, an RFID antenna may be positioned in a handle of a device. The handle of a device is sufficiently spacious to accommodate a large sized RFID antenna for efficient performance and is sufficiently separate from the metallic and/or lossy components of the device to avoid interference from these components which may degrade RFID antenna performance. This implementation may degrade RFID antenna performance because RFID antennas are tuned based on parameters (e.g., impedance and frequency) for directional performance, in which RFID tags, are read at a certain read range in front of the device. As such, different operating modes (e.g., a presentation operating mode, a handheld operating mode, etc.) of the device can detune (e.g., shift) an impedance and/or frequency of an RFID antenna positioned in the handle thereby rendering the device inoperable. For example, a load (such as a hand of a user) proximate to the handle of the device can detune (e.g., shift) an impedance and/or frequency of an RFID antenna positioned in the handle such that the device may not receive and/or transmit data and/or operate within an intended frequency bandwidth. An increase in power to the RFID antenna can mitigate detuning of the RFID antenna but such a power increase can violate the rules and regulations of the Federal Communications Commission (FCC) and/or degrade battery performance of the device. Additionally, tuning an RFID antenna based on an average of possible detuning conditions can mitigate detuning of the RFID antenna in response to these detuning conditions but does not allow for optimal performance of the RFID antenna and/or device.

Accordingly, a system, device, and method for dynamic tuning of an RFID antenna of an RFID-integrated indicia reading device that yields a compact and ergonomically user-friendly device would be beneficial. What is needed is a system, device, and method for dynamically tuning an RFID antenna of an RFID-integrated device based on operating modes of the device to maintain an impedance and frequency of the RFID antenna without necessitating an increase in power to the RFID antenna.

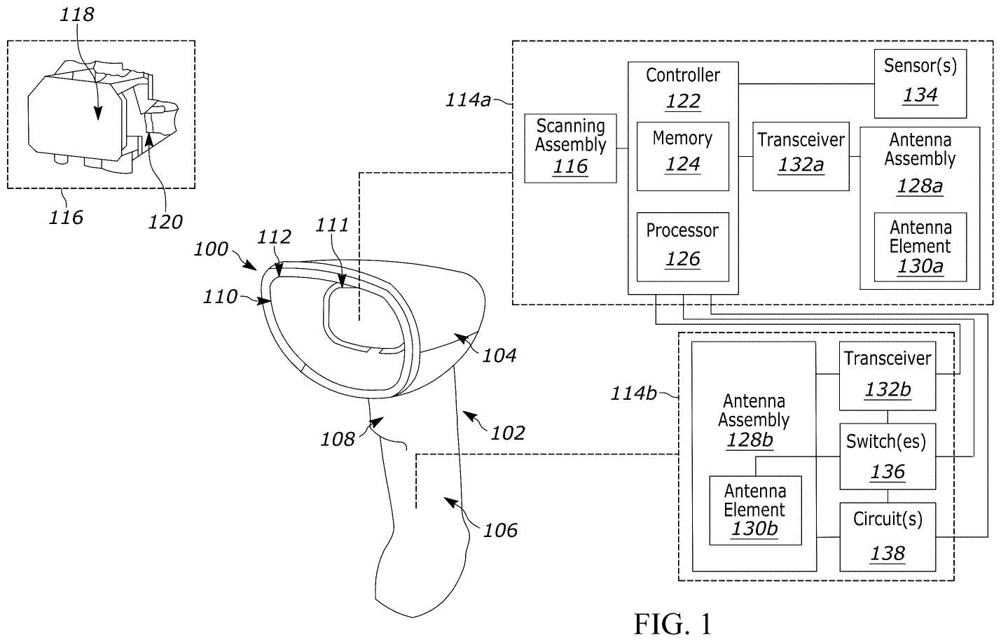

FIG. 1 is a diagram 100 illustrating an embodiment of the present disclosure. A device 100 may include a housing 102 having a head portion 104, a handle portion 106, and a trigger portion 108. The head portion 104 of the housing 102 may include a bezel 110 having a first opening 111, a second opening 112, a bezel body (not shown) extending from the first opening 111 to the second opening 112 of the bezel 110, and components 114a. The components 114a may include a scanning assembly 116 having a scan window 118 and a scanning engine 120, a controller 122 having a memory 124 and a processor 126, a first antenna assembly 128a having at least one antenna element 130a (hereinafter referred to as “antenna 130a”), a first transceiver 132a, and one or more sensors 134 (hereinafter referred to as “sensor 134” or “sensor(s) 134”). The handle portion 106 may include components 114b. The components 114b may include a second antenna assembly 128b having at least one antenna element 130b (hereinafter referred to as “antenna 130b”), a second transceiver 132b, switch(es)136 (hereinafter referred to as “switch(es) 136”, “switch 136a”, “switch 136b”, “switch 136c”, and/or “switch 136d”), and circuit(s) 138 (hereinafter referred to as “circuit 138a” and/or “circuit 138b”).

The scanning assembly 116 is configured to enable the reading of barcodes by the device 100. The scanning engine 120 may include an illumination system, an imaging system, and an aiming system to provide for the scanning and decoding of barcodes. The scanning engine 120 may be coupled to the scan window 118. The scan window 118 protects the scanning engine 120 and prevents foreign objects from entering and damaging the device 100. The scan window 118 may be, for example, a sheet of glass. The bezel 110 serves to further protect the scanning engine 120 and prevent excess light exterior to the scan window 118 from entering the scan engine 120 to ensure proper operation. The scan window 118 at least partially covers the first opening 111 of the bezel 110, such that the scanning engine 120 coupled to the scan window 118 is configured to read barcodes by scanning out of the scan window 118, through the first opening 111, along the bezel body (not shown), and out of the second opening 112.

The first antenna assembly 128a, including the antenna 130a, may be arranged proximate to the scanning assembly 116 within the head portion 104. The antenna 130a may be one or more of a Bluetooth®, WiFi®, or RFID antenna. The first antenna assembly 128a may further include or communicatively couple to a first transceiver 132a which provides for Bluetooth®, WiFi®, and/or RFID transmit/receive functionality to provide the device 100 with Bluetooth®, WiFi®, and/or RFID capabilities.

The controller 122 includes a memory 124 and a processor 126 (e.g., one or more microprocessors, controllers, and/or any suitable type of processor) and is communicatively coupled to the scanning assembly 116, the first antenna assembly 128a via the transceiver 132a, the second antenna assembly 128b via the transceiver 132b, and the sensor(s) 134.

The memory 124 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. A computer program or computer based product, application, code and/or other computing instructions described herein may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor 126 (e.g., working in connection with the respective operating system in the memory 204) to facilitate, implement, or perform the machine readable instructions, methods, processes, elements or limitations, as illustrated, depicted, or described for the various flowcharts, illustrations, diagrams, figures, and/or other disclosure herein. The program code may be implemented in any desired program language, and may be implemented as machine code, assembly code, byte code, interpretable source code or the like.

The processor 126 can access (e.g., via a memory controller) the memory 124 (e.g., volatile memory, non-volatile memory), and interact with the memory 124 to obtain machine-readable instructions stored in the memory 124 corresponding to the operations represented by the diagrams and flowcharts of this disclosure. It should be understood that each of the processor 126, the memory 124, and/or any other component of the controller 122 may include and/or otherwise represent multiple processors, memories, components, etc. The processor 126 may be coupled to the memory 124 via a computer bus responsible for transmitting electronic data, data packets, or otherwise electronic signals to and from the processor 126 and the memory 124 to implement or perform the machine-readable instructions, methods, processes, elements or limitations, as illustrated, depicted, or described for the various flowcharts, illustrations, diagrams, figures, and/or other disclosure herein. Additionally, the processor 126 may be coupled to the transceiver 132b, switch(es) 136 and the circuit(s) 138.

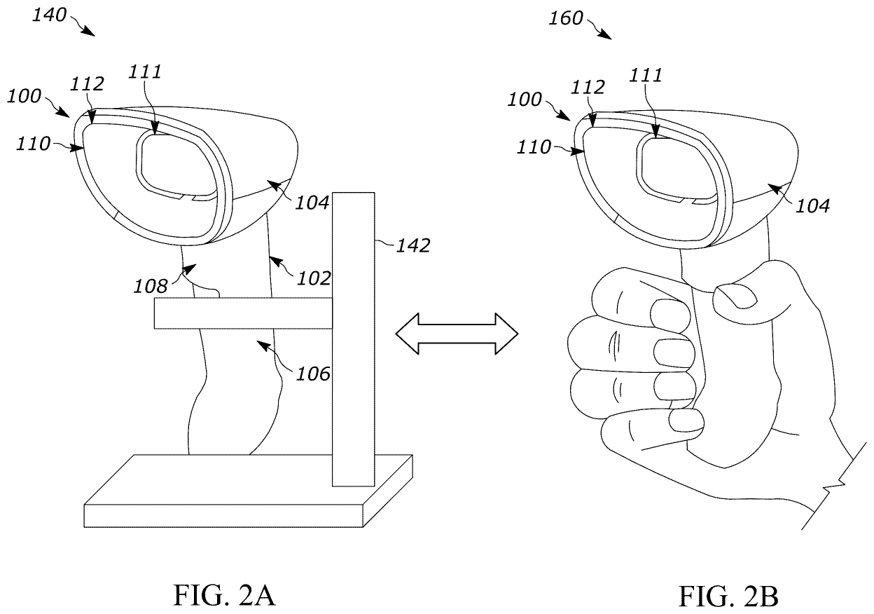

As described in further detail below, the controller 122 may be configured to determine an operating mode of the device 100 and dynamically tune the antenna 130b of the second antenna assembly 128b. For example, the controller 122 may be configured to determine an operating mode of a device from a first mode (e.g., a presentation operating mode) and a second mode (e.g., a handheld operating mode) or additional modes. The first mode may be indicative of a fixed state of the device 100. For example, the device 100 may be positioned in a cradle 142 (as shown in FIG. 2A) configured to support the device 100 in the first mode. The second mode may be indicative of a mobile state of the device 100. For example, the device 100 may be held by a user (as shown in FIG. 2B). The controller 122 may determine an operating mode of the device 100 based on one or more of a signal from the sensor(s) 134 (e.g., an accelerometer, a reed switch, a hall effect sensor, a capacitive touch sensor, an optical sensor, a gyroscope, and/or any suitable sensor or combination of sensors), the presence or absence of power to the device 100 from the cradle 142, a mechanical switch of the device 100 indicating a first or second mode, the presence or absence of an external load applied to the antenna 130b of the second antenna assembly 128b, an input to the trigger portion 108, and any other suitable method and/or mechanism.

Additionally, the controller 122 may be configured to dynamically tune the antenna 130b of the second antenna assembly 128b by, responsive to determining the operating mode of the device 100 is the first mode, controlling a first circuit 138a to drive a first impedance of the antenna 130b associated with the first mode to a target impedance to operate the antenna 130b at a predetermined power level in a first frequency bandwidth and a predetermined range. The controller 122 may also be configured to dynamically tune the antenna 130b of the second antenna assembly 128b by, responsive to determining the operating mode of the device 100 is the second mode, controlling a second circuit 138b to drive a second impedance of the antenna 130b associated with the second mode and different from the first impedance to the target impedance to operate the antenna 130b at the predetermined power level in the first frequency bandwidth and the predetermined range.

As mentioned above, the components 114b may include a second antenna assembly 128b having at least one antenna element 130b, a second transceiver 132b, switch(es)136 and circuit(s) 138. The antenna 130b may be an RFID antenna having an intrinsic impedance (e.g., 50Ω +0j) and a target impedance. The target impedance matches an impedance of the transceiver 132b coupled to the antenna 130b, via the second antenna assembly 128b, to provide maximum power transfer to the antenna 130b and operate the antenna 130b at a predetermined power level and a predetermined range. The target impedance changes based on the operating mode of the device 100. The second antenna assembly 128b may further include or communicatively couple to a second transceiver 132b which provides for radio frequency (RF) transmit/receive functionality to provide the device 100 with RFID capabilities. Accordingly, the second antenna assembly 128b and the second transceiver 132b are RFID capable and provide the device 100 with the ability to read an RFID tag. In other embodiments, the antenna 130b may be any suitable antenna (e.g., Bluetooth® and/or WiFi®), and the second transceiver 132 may provide for Bluetooth® and/or WiFi® transmit/receive functionality to provide the device 100 with Bluetooth® and/or WiFi® capabilities. The switch(es) 136 are communicatively coupled to the processor 126 and the antenna 130b. The switch(es) 136 may be a single pole single throw (SPST) RF switch or a double throw (SPDT) RF switch. The circuit(s) 138 are communicatively coupled to the processor 126 and the antenna 130b. The circuit(s) 138 may be matching networks comprised of one or more inductors and capacitors.

The trigger portion 108 may be and/or include a trigger or a button. The trigger portion 108 may communicatively couple to the controller 122 to enable use of the device 100 upon actuation of the trigger portion 108. For example, when actuated or depressed, the trigger portion 108 can enable the reading of barcodes via the scanning engine 120, and the reading of RFID tags via the second antenna assembly 128b and the second transceiver 132b. In other embodiments, the trigger portion 108, when actuated or depressed, can enable the reading of RFID tags via one or more of the first antenna assembly 128a and first transceiver 132a, and the second antenna assembly 128b and the second transceiver 132b. The trigger portion 108 may extend from the head portion 104 or the handle portion 106. The housing 102 may also include ergonomic indentions on the handle portion 106 that provide for the device 100 to be easily and comfortably handled by a user. The handle portion 106 and the head portion 104 may be modular and joined together to form the housing 102. Alternatively, the handle portion 106 and the head portion 104 may be unitary and formed as a molded housing 102.

FIG. 2A is a diagram 140 illustrating an example mode of the device 100 of FIG. 1 and FIG. 2B is a diagram 160 illustrating another example mode of the device 100 of FIG. 1. For example, FIG. 2A illustrates a first mode (e.g., a presentation operating mode) indicative of a fixed state of the device 100 and FIG. 2B illustrates a second mode (e.g., a handheld operating mode) indicative of a mobile state of the device 100.

Referring to FIG. 2A, the device 100 may be positioned in a cradle 142 configured to support the device 100 in the first mode. For example, the cradle may hold the device 100 in place and supply power to a battery thereof. The cradle 142 may be positioned on a countertop or like support surface. The cradle 142 can deactivate the trigger portion 108 such that the device 100 periodically or continuously performs barcode and/or RFID tag reading. As such, the device 100 may be utilized as a fixed or stationary hands-free workstation in which barcode or tag bearing objects are successively slid, swiped, or presented to a front of the device 100.

Referring to FIG. 2B, the device 100 may be held by a user in a second mode. For example, a user may pick up the device 100, aim the device 100 at barcode or tag bearing objects, and manually actuate or depress the trigger portion 108 (e.g., a trigger or button) to activate barcode and/or RFID tag reading.

The device 100 may switch between the first and second modes based on the use thereof. For example, the device 100 may be in the first mode (e.g., a presentation operating mode) when positioned in the cradle 142 situated on a support surface of a point of sale station and may switch to the second mode (e.g., a handheld operating mode) when a user removes the device 100 from the cradle 142 to read an RFID tag of a large, bulky, and/or heavy object that cannot be readily slid, swiped, or presented to a front of the device 100. In another example, a user utilizing the device 100 in the second mode may position the device 100 in the cradle 142 to return the device 100 to the first mode.

As mentioned above, the controller 122 may determine an operating mode of the device 100 based on one or more of a signal from the sensor(s) 134 (e.g., an accelerometer, a reed switch, a hall effect sensor, a capacitive touch sensor, an optical sensor, a gyroscope, and/or any suitable sensor or combination of sensors), the presence or absence of power to the device 100 from the cradle 142, a mechanical switch of the device 100 indicating a first or second mode, the presence or absence of an external load applied to the antenna 130b of the second antenna assembly 128b, an input to the trigger portion 108, and any other suitable method and/or mechanism. For example, the controller 122 may determine a switch in an operating mode of the device 100 from the first mode to the second mode when the device 100 is removed from the cradle 142 due to an absence of power to the device 100 from the cradle 142 and/or a signal received from the sensor(s) 134 indicative of motion and/or decoupling from the cradle 142. In another example, the controller 122 may determine a switch in an operating mode of the device 100 from the second mode to the first mode when the device 100 is positioned in the cradle 142 due to the presence of power to the device 100 from the cradle 142 and/or a signal received from the sensor(s) 134 indicative of the device 100 being stationary and/or coupled to the cradle 142. As discussed in further detail below, the controller 122 may determine a switch in an operating mode of the device 100 from the first mode to the second mode based on the presence of an external load applied to the antenna 130b of the second antenna assembly 128b. For example, when a user removes the device 100 from the cradle 142, a hand of the user generally contacts or is proximate to the handle portion 106 of the device 100 resulting in the application of an external load to the antenna 130b of the second antenna assembly 128b.

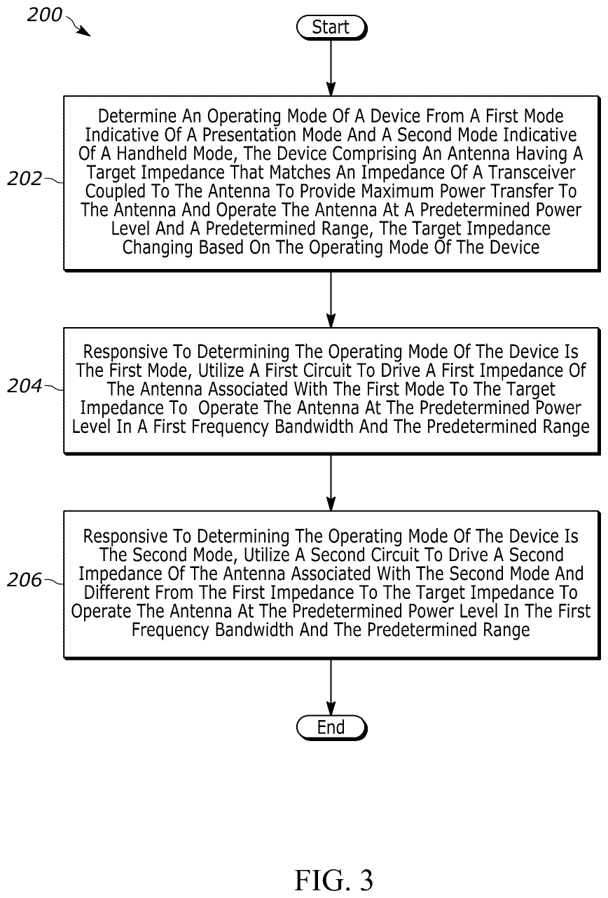

FIG. 3 is a flowchart 200 illustrating processing steps of an embodiment of the present disclosure. In particular, FIG. 3 illustrates processing steps for dynamically tuning the antenna 130b. Beginning in step 202, the method determines an operating mode of a device 100 from a first mode and second mode. The first mode is indicative of a fixed state (e.g., a presentation operation mode) of the device 100 and the second mode is indicative of a mobile state (e.g., a handheld operating mode) of the device 100. The device 100 comprises an antenna 130b having a target impedance that matches an impedance of a transceiver 132b coupled to the antenna 130b to provide maximum power transfer to the antenna 130b and operate the antenna 130b at a predetermined power level and a predetermined range. The target impedance changes based on the operating mode of the device 100. For example, in the second mode, a hand of a user contacts or is proximate to a handle portion 106 of the device 100 resulting in the application of an external load to the antenna element 130b that detunes (e.g., shifts) an impedance and/or frequency of the antenna 130b positioned in the handle 106. The device 100 may be an RFID reader and the antenna 130b may be an RFID antenna. In an embodiment, the device 100 may be a barcode scanner, a Bluetooth reader or an RFID reader or any suitable combination thereof and the antenna 130b may be a Bluetooth®, WiFi®, or RFID antenna.

In a variation of the embodiment, the method determines the operating mode of the device 100 from the first mode and the second mode by determining whether an external load is applied to the antenna 130b. The external load may be a hand of the user. Generally, in the second mode, a hand of a user contacts or is proximate to a handle portion 106 of the device 100 resulting in the application of an external load to the antenna element 130b that detunes (e.g., shifts) an impedance and/or frequency of the antenna 130b positioned in the handle 106. Responsive to determining the external load is not applied to the antenna 130b, the method determines the operating mode of the device 100 is the first mode. Alternatively, responsive to determining the external load is applied to the antenna 130b, the method determines the operating mode of the device 100 is the second mode.

In another variation of the embodiment, the method determines the operating mode of the device 100 from the first mode and the second mode by detecting, via a sensor 134, a state of the device 100 from a fixed state and a mobile state. For example, the device 100 is positioned in a cradle 142 in the fixed state and is held by a user in the mobile state. Responsive to detecting the fixed state, the method determines the operating mode of the device 100 is the first mode. Alternatively, responsive to detecting the mobile state, the method determines the operating mode of the device 100 is the second mode. The sensor 134 may be one or more of an accelerometer, a reed switch, a hall effect sensor, a capacitive touch sensor, an optical sensor, a gyroscope, and/or any suitable sensor or combination of sensors).

In yet another variation of the embodiment, the method determines the operating mode of the device 100 from the first mode and the second mode by detecting, via the sensor 134, a state of the device 100 from a fixed state and a mobile state and by determining whether an external load is applied to the antenna 130b. For example, responsive to detecting the fixed state, the method determines the operating mode of the device 100 is the first mode, and responsive to detecting the mobile state, the method determines whether an external load is applied to the antenna 130b. Additionally, responsive to determining the external load is not applied to the antenna 130b, the method determines the operating mode of the device 100 is the first mode, and responsive to determining the external load is applied to the antenna 130b, the method determines the operating mode of the device 100 is the second mode. In this way, the method may ascertain whether the device 100 is temporarily (e.g., accidentally) decoupled from a cradle 142 and positioned back in the cradle 142 or removed from the cradle 142 and held by a user.

In step 204, responsive to determining the operating mode of the device 100 is the first mode, the method utilizes a first circuit 138a to drive a first impedance of the antenna 130b associated with the first mode to the target impedance to operate the antenna 130b at the predetermined power level in a first frequency bandwidth and the predetermined range.

In step 206, responsive to determining the operating mode of the device 100 is the second mode, the method utilizes a second circuit 138b to drive a second impedance of the antenna 130b associated with the second mode and different from the first impedance to the target impedance to operate the antenna 130b at the predetermined power level in the first frequency bandwidth and the predetermined range. The first and second circuits 138a and 138b may be matching networks comprised of inductors and capacitors. The predetermined power level may be set based on an intended application and per range and battery expectations. For example, the predetermined power level may be set to +22 dbm to yield a predetermined read range of three feet. The frequency bandwidth range may be 860^{˜}960 MHz or 900^{˜}928 MHz depending on the intended application.

In a variation of the embodiment, responsive to determining the operating mode of the device 100 is the first mode, the method may further utilize the first circuit 138a to drive the first impedance of the antenna 130b associated with the first mode to the target impedance to operate the antenna 130b at the predetermined power level in the first frequency bandwidth and the predetermined range. In this way, the method may drive the first impedance of the antenna 130b associated with the first mode to the target impedance of the antenna 130b when the device 100 switches from the second mode to the first mode.

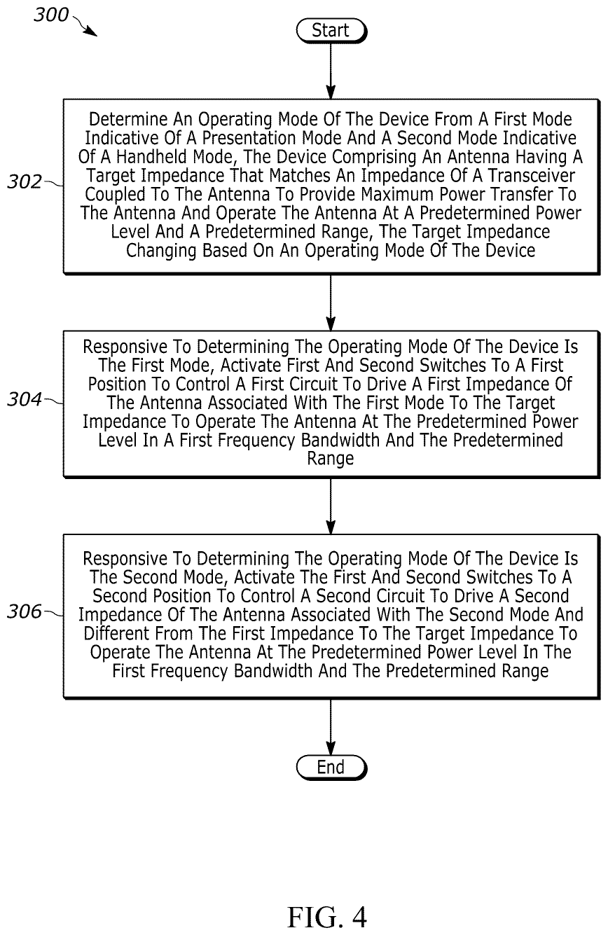

FIG. 4 is a flowchart 300 illustrating processing steps of another embodiment of the present disclosure. In particular, FIG. 4 illustrates processing steps for dynamically tuning the antenna 130b. Beginning in step 302, the method determines, via a controller 122, an operating mode of a device 100 from a first mode and second mode. The first mode is indicative of a fixed state (e.g., a presentation operating mode) of the device 100 and the second mode is indicative of a mobile state (e.g., a handheld operating mode) of the device 100. The device 100 comprises an antenna 130b having a target impedance that matches an impedance of a transceiver 132b coupled to the antenna 130b to provide maximum power transfer to the antenna 130b and operate the antenna 130b at a predetermined power level and a predetermined range. The target impedance changes based on the operating mode of the device 100. For example, in the second mode, a hand of a user contacts or is proximate to a handle portion 106 of the device 100 resulting in the application of an external load to the antenna 130b that detunes (e.g., shifts) an impedance and/or frequency of the antenna 130b positioned in the handle 106. As discussed in further detail below, the device 100 also comprises first and second switches 136a and 136b. Each of the first and second switches 136a and 136b may be a single pole single throw (SPST) RF switch or a double throw (SPDT) RF switch. The device 100 may be an RFID reader and the antenna 130b may be an RFID antenna. In an embodiment, the device 100 may be a barcode scanner, a Bluetooth reader or an RFID reader or any suitable combination thereof and the antenna 130b may be a Bluetooth®, WiFi®, or RFID antenna.

In a variation of the embodiment, the method determines, via the controller 122, the operating mode of the device 100 from the first mode and the second mode by determining whether an external load is applied to the antenna 130b. The external load may be a hand of the user. Generally, in the second mode, a hand of a user contacts or is proximate to a handle portion 106 of the device 100 resulting in the application of an external load to the antenna 130b that detunes (e.g., shifts) an impedance and/or frequency of the antenna 130b positioned in the handle 106. Responsive to determining the external load is not applied to the antenna 130b, the method determines the operating mode of the device 100 is the first mode. Alternatively, responsive to determining the external load is applied to the antenna 130b, the method determines the operating mode of the device 100 is the second mode.

In another variation of the embodiment, the method determines, via the controller 122, the operating mode of the device 100 from the first mode and the second mode by detecting, via a sensor 134, a state of the device 100 from a fixed state and a mobile state. For example, the device 100 is positioned in a cradle 142 in the fixed state and is held by a user in the mobile state. Responsive to detecting the fixed state, the method determines the operating mode of the device 100 is the first mode. Alternatively, responsive to detecting the mobile state, the method determines the operating mode of the device 100 is the second mode. The sensor 134 may be one or more of an accelerometer, a reed switch, a hall effect sensor, a capacitive touch sensor, an optical sensor, a gyroscope, and/or any suitable sensor or combination of sensors.

In yet another variation of the embodiment, the method determines, via the controller 122, the operating mode of the device 100 from the first mode and the second mode by detecting, via the sensor 134, a state of the device 100 from a fixed state and a mobile state and by determining whether an external load is applied to the antenna 130b. For example, responsive to detecting the fixed state, the method determines the operating mode of the device 100 is the first mode, and responsive to detecting the mobile state, the method determines whether an external load is applied to the antenna 130b. Additionally, responsive to determining the external load is not applied to the antenna 130b, the method determines the operating mode of the device 100 is the first mode, and responsive to determining the external load is applied to the antenna 130b, the method determines the operating mode of the device 100 is the second mode. In this way, the method may ascertain whether the device 100 is temporarily (e.g., accidentally) decoupled from a cradle 142 and positioned back in the cradle 142 or removed from the cradle 142 and held by a user.

In step 304, responsive to determining the operating mode of the device 100 is the first mode, the method activates, via the controller 122, the first and second switches 136a and 136b to a first position to control a first circuit 138a to drive a first impedance of the antenna 130b associated with the first mode to the target impedance to operate the antenna 130b at the predetermined power level in a first frequency bandwidth and the predetermined range.

In step 306, responsive to determining the operating mode of the device 100 is the second mode, the method activates, via the controller 122, the first and second switches 136a and 136b to a second position to control a second circuit 138b to drive a second impedance of the antenna 130b associated with the second mode and different from the first impedance to the target impedance to operate the antenna 130b at the predetermined power level in the first frequency bandwidth and the predetermined range. The first and second circuits may be matching networks comprised of inductors and capacitors. The predetermined power level may be set based on an intended application and per range and battery expectations. For example, the predetermined power level may be set to +22 dbm to yield a predetermined read range of three feet. The frequency bandwidth range may be 860^{˜}960 MHz or 900^{˜}928 MHz depending on the intended application.

In a variation of the embodiment, responsive to determining the operating mode of the device 100 is the first mode, the method may further activate, via the controller 122, the first and second switches 136a and 136b to the first position to control the first circuit 138a to drive the first impedance of the antenna 130b associated with the first mode to the target impedance to operate the antenna 130b at the predetermined power level in the first frequency bandwidth and the predetermined range. In this way, the method may drive the first impedance of the antenna 130b associated with the first mode to the target impedance of the antenna 130b when the device 100 switches from the second mode to the first mode.

In a variation of the embodiment, the method may select, via the controller 122, a first RF path in response to determining the operating mode of the device 100 is the first mode. The method may also activate, via the controller 122, the first and second switches 136a and 136b to the first position to control the first circuit 138a to drive the first impedance of the antenna 130b associated with the first mode to the target impedance to operate the antenna 130b at the predetermined power level in the first frequency bandwidth and the predetermined range where the first position is associated with the first RF path. Alternatively, the method may select, via the controller 122, a second RF path in response to determining the operating mode of the device 100 is the second mode. The method may also activate, via the controller 122, the first and second switches 136a and 136b to the second position to drive the second impedance of the antenna 130b associated with the second mode and different from the first impedance to the target impedance to operate the antenna 130b at the predetermined power level in the first frequency bandwidth and the predetermined range where the second position is associated with the second RF path. In this way, the method can utilize two RF paths to maintain impedance and frequency tuning of the antenna element 130b. In particular, the first RF path accounts for when an external load is not applied to the antenna element 130b in the first mode (e.g., a presentation operating mode) and the second RF path accounts for when an external load is applied to the antenna element 130b in the second mode (e.g., a handheld operating mode).

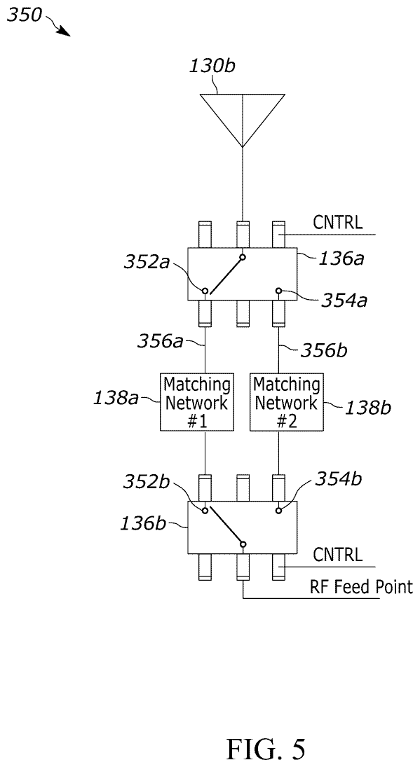

FIG. 5 is a diagram 350 illustrating the processing steps of FIG. 4. As shown in FIG. 5, a first switch 136a includes a first position 352a and a second position 354a and a second switch 136b includes a first position 352b and a second position 354b. The first switch 136a is coupled to an antenna 130b. Each of the first switch 136a and the second switch 136b is a SPDT RF switch. Additionally, each of the first switch 136a and the second switch 136b receives a control (CNTRL) signal from the controller 122 of the device 100 to activate the first and second switches 136a and 136b to the first positions 352a and 352b to control a first matching network 138a (e.g., a first circuit 138a) to drive the first impedance of the antenna 130b associated with the first mode to the target impedance to operate the antenna 130b at the predetermined power level in the first frequency bandwidth and the predetermined range. The first positions 352a and 352b are associated with a first RF path 356a. The first RF path 356a accounts for when an external load is not applied to the antenna 130b in the first mode (e.g., a presentation operating mode). Alternatively, each of the first switch 136a and the second switch 136b may receive a control (CNTRL) signal from the controller 122 to activate the first and second switches 136a and 136b to the second positions 354a and 354b to drive the second impedance of the antenna 130b associated with the second mode and different from the first impedance to the target impedance to operate the antenna 130b at the predetermined power level in the first frequency bandwidth and the predetermined range. The second positions 354a and 354b are associated with a second RF path 356b. The second RF path 356b accounts for when an external load is applied to the antenna element 130b in the second mode (e.g., a handheld operating mode). The first and second matching networks 356a and 356b are isolated from one another and are comprised of one or more inductors and capacitors. As mentioned above, the first RF path 356a and the second RF path 356b provide for maintaining an impedance and frequency tuning of the antenna 130b during different operating modes of the device 100 without necessitating an increase in power to the antenna 130b. In particular, the first RF path 356a accounts for when an external load is not applied to the antenna 130b in the first mode (e.g., a presentation operating mode) and the second RF path 356b accounts for when an external load is applied to the antenna 130b in the second mode (e.g., a handheld operating mode).

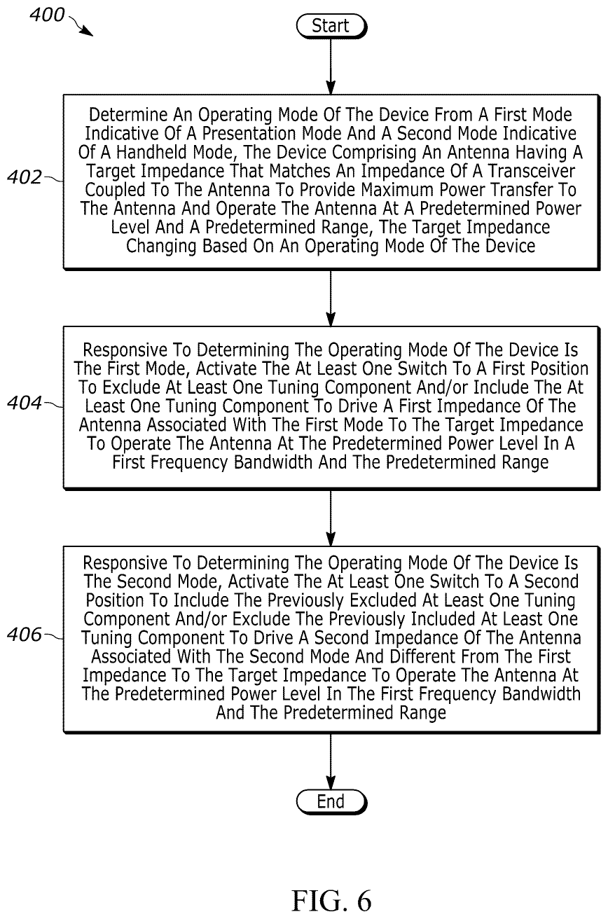

FIG. 6 is a flowchart 400 illustrating processing steps of another embodiment of the present disclosure. In particular, FIG. 6 illustrates processing steps for dynamically tuning the antenna 130b. Beginning in step 402, the method determines, via a controller 122, an operating mode of a device 100 from a first mode and second mode. The first mode is indicative of a fixed state (e.g., a presentation operating mode) of the device 100 and the second mode is indicative of a mobile state (e.g., a handheld operating mode) of the device 100. The device 100 comprises an antenna 130b having a target impedance that matches an impedance of a transceiver 132b coupled to the antenna 130b to provide maximum power transfer to the antenna 130b and operate the antenna 130b at a predetermined power level and a predetermined range. The target impedance changes based on the operating mode of the device 100. For example, in the second mode, a hand of a user contacts or is proximate to a handle portion 106 of the device 100 resulting in the application of an external load to the antenna 130b that detunes (e.g., shifts) an impedance and/or frequency of the antenna 130b positioned in the handle 106. As discussed in further detail below, the device 100 also comprises switches 136c and 136d. Each of the switches 136c and 136d may be a SPST RF switch. The device 100 may be an RFID reader and the antenna 130b may be an RFID antenna. In an embodiment, the device 100 may be a barcode scanner, a Bluetooth reader or an RFID reader or any suitable combination thereof and the antenna 130b may be a Bluetooth®, WiFi®, or RFID antenna.

In a variation of the embodiment, the method determines, via the controller 122, the operating mode of the device 100 from the first mode and the second mode by determining whether an external load is applied to the antenna 130b. The external load may be a hand of the user. Generally, in the second mode, a hand of a user contacts or is proximate to a handle portion 106 of the device 100 resulting in the application of an external load to the antenna 130b that detunes (e.g., shifts) an impedance and/or frequency of the antenna 130b positioned in the handle 106. Responsive to determining the external load is not applied to the antenna 130b, the method determines the operating mode of the device 100 is the first mode. Alternatively, responsive to determining the external load is applied to the antenna 130b, the method determines the operating mode of the device 100 is the second mode.

In another variation of the embodiment, the method determines, via the controller 122, the operating mode of the device 100 from the first mode and the second mode by detecting, via a sensor 134, a state of the device 100 from a fixed state and a mobile state. For example, the device 100 is positioned in a cradle 142 in the fixed state and is held by a user in the mobile state. Responsive to detecting the fixed state, the method determines the operating mode of the device 100 is the first mode. Alternatively, responsive to detecting the mobile state, the method determines the operating mode of the device 100 is the second mode. The sensor 134 may be one or more of an accelerometer, a reed switch, a hall effect sensor, a capacitive touch sensor, an optical sensor, a gyroscope, and/or any suitable sensor or combination of sensors.

In yet another variation of the embodiment, the method determines, via the controller 122, the operating mode of the device 100 from the first mode and the second mode by detecting, via the sensor 134, a state of the device 100 from a fixed state and a mobile state and by determining whether an external load is applied to the antenna 130b. For example, responsive to detecting the fixed state, the method determines the operating mode of the device 100 is the first mode, and responsive to detecting the mobile state, the method determines whether an external load is applied to the antenna 130b. Additionally, responsive to determining the external load is not applied to the antenna 130b, the method determines the operating mode of the device 100 is the first mode, and responsive to determining the external load is applied to the antenna 130b, the method determines the operating mode of the device 100 is the second mode. In this way, the method may ascertain whether the device 100 is temporarily (e.g., accidentally) decoupled from a cradle 142 and positioned back in the cradle 142 or removed from the cradle 142 and held by a user.

In step 404, responsive to determining the operating mode of the device 100 is the first mode, the method activates, via the controller 122, at least one switch (e.g., a switch 136c and/or 136d) to a first position to exclude at least one tuning component and/or include the at least one tuning component (e.g., an inductor or capacitor of a circuit) to drive a first impedance of the antenna 130b associated with the first mode to the target impedance to operate the antenna 130b at the predetermined power level in a first frequency bandwidth and the predetermined range.

In step 406, responsive to determining the operating mode of the device 100 is the second mode, the method activates, via the controller 122, the at least one switch (e.g., the switch 136c and/or 136d) to a second position to include the previously excluded at least one tuning component or exclude the previously included at least one tuning component (e.g., the inductor or capacitor of the circuit) to drive a second impedance of the antenna 130b associated with the second mode and different from the first impedance to the target impedance to operate the antenna 130b at the predetermined power level in the first frequency bandwidth and the predetermined range.

In a variation of the embodiment, the method may further activate, via the controller 122, the at least one switch (e.g., the switch 136c and/or 136d) to the first position to exclude the at least one tuning component or include the at least one tuning component (e.g., the inductor or capacitor of the circuit) to drive the first impedance of the antenna 130b associated with the first mode to the target impedance to operate the antenna 130b at the predetermined power level in the first frequency bandwidth and the predetermined range. In this way, the method may drive the first impedance of the antenna 130b associated with the first mode to the target impedance of the antenna 130b when the device 100 switches from the second mode to the first mode.

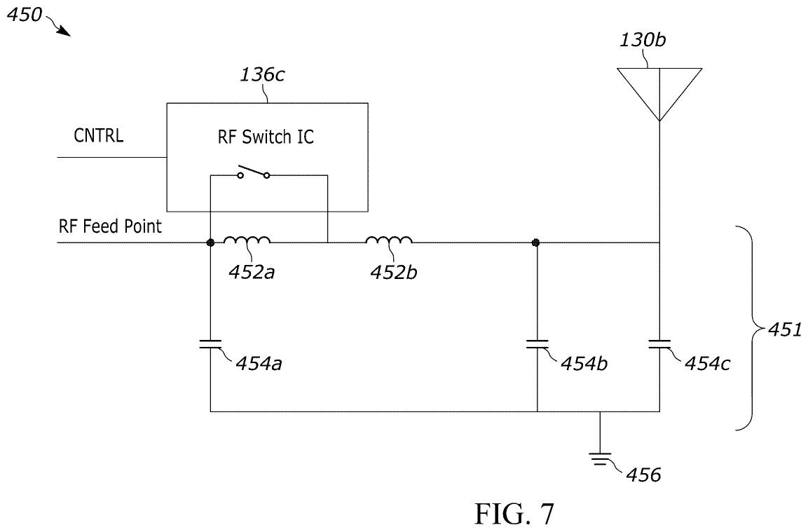

FIG. 7 is a diagram 450 illustrating the processing steps of FIG. 6. As shown in FIG. 7, a circuit 451 includes inductors 452a and 452b, capacitors 454a, 454b, and 454c, and a ground 456. The circuit 451 is coupled to an antenna 130b and a switch 136c. The switch 136c includes a first position (e.g., when the switch is open) and a second position (e.g., when the switch is closed). The switch 136c is a SPST RF switch. In response to determining the operating mode of the device 100 is the first mode, the switch 136c receives a control (CNTRL) signal from the controller 122 of the device 100 to activate the switch 136c to the first position (e.g., the open position) to include a tuning component (e.g., an inductor 452a of the circuit 451) to drive a first impedance of the antenna 130b associated with the first mode to the target impedance to operate the antenna 130b at the predetermined power level in a first frequency bandwidth and the predetermined range. Alternatively, in response to determining the operating mode of the device 100 is the second mode, the switch 136c may receive a control (CNTRL) signal from the controller 122 to activate the switch 136c to the second position (e.g., the closed position) to exclude the previously included tuning component (e.g., the inductor 452a of the circuit 451) to drive a second impedance of the antenna 130b associated with the second mode and different from the first impedance to the target impedance to operate the antenna 130b at the predetermined power level in the first frequency bandwidth and the predetermined range. In this way, the controller 122 activates the switch 136c to maintain an impedance and frequency tuning of the antenna element 130b during different operating modes of the device 100 without necessitating an increase in power to the antenna 130b. In particular, the first position (e.g., the open position) accounts for when an external load is not applied to the antenna element 130b in the first mode (e.g., a presentation operating mode) and the second position (e.g., the closed position) accounts for when an external load is applied to the antenna element 130b in the second mode (e.g., a handheld operating mode). In a variation of the embodiment, the first position (e.g., the open position) accounts for when an external load is applied to the antenna element 130b in the first mode (e.g., a handheld operating mode) and the second position (e.g., the closed position) accounts for when an external load is not applied to the antenna element 130b in the second mode (e.g., a presentation operating mode).

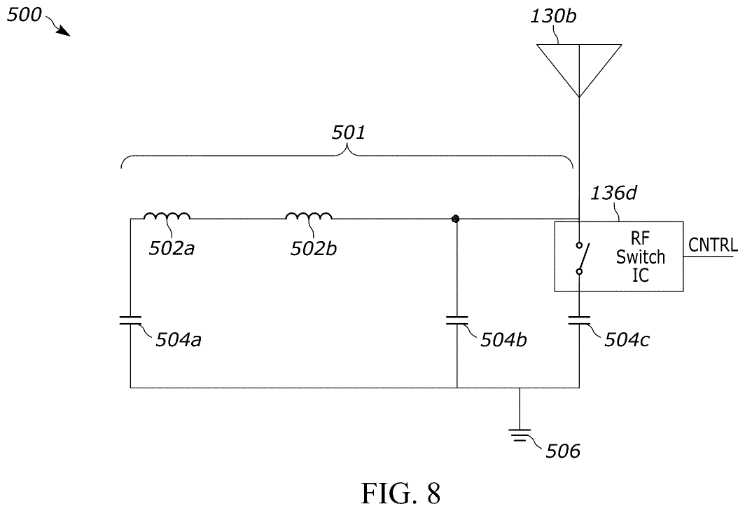

FIG. 8 is a diagram 500 illustrating the processing steps of FIG. 6. As shown in FIG. 8, a circuit 501 includes inductors 502a and 502b, capacitors 504a, 504b, and 504c, and a ground 506. The circuit 501 is coupled to an antenna 130b and a switch 136d. The switch 136d includes a first position (e.g., when the switch is open) and a second position (e.g., when the switch is closed). The switch 136d is a SPST RF switch. In response to determining the operating mode of the device 100 is the first mode, the switch 136d receives a control (CNTRL) signal from the controller 122 of the device 100 to activate the switch 136d to the first position (e.g., the open position) to exclude a tuning component (e.g., a capacitor 504c of the circuit 501) to drive a first impedance of the antenna 130b associated with the first mode to the target impedance to operate the antenna 130b at the predetermined power level in a first frequency bandwidth and the predetermined range. Alternatively, in response to determining the operating mode of the device 100 is the second mode, the switch 136d may receive a control (CNTRL) signal from the controller 122 to activate the switch 136d to the second position (e.g., the closed position) to include the previously excluded tuning component (e.g., the capacitor 504c of the circuit 501) to drive a second impedance of the antenna 130b associated with the second mode and different from the first impedance to the target impedance to operate the antenna 130b at the predetermined power level in the first frequency bandwidth and the predetermined range. In this way, the controller 122 activates the switch 136d to maintain an impedance and frequency tuning of the antenna element 130b during different operating modes of the device 100 without necessitating an increase in power to the antenna 130b. In particular, the first position (e.g., the open position) accounts for when an external load is not applied to the antenna 130b in the first mode (e.g., a presentation operating mode) and the second position (e.g., the closed position) accounts for when an external load is applied to the antenna 130b in the second mode (e.g., a handheld operating mode). In a variation of the embodiment, the first position (e.g., the open position) accounts for when an external load is applied to the antenna element 130b in the first mode (e.g., a handheld operating mode) and the second position (e.g., the closed position) accounts for when an external load is not applied to the antenna element 130b in the second mode (e.g., a presentation operating mode).

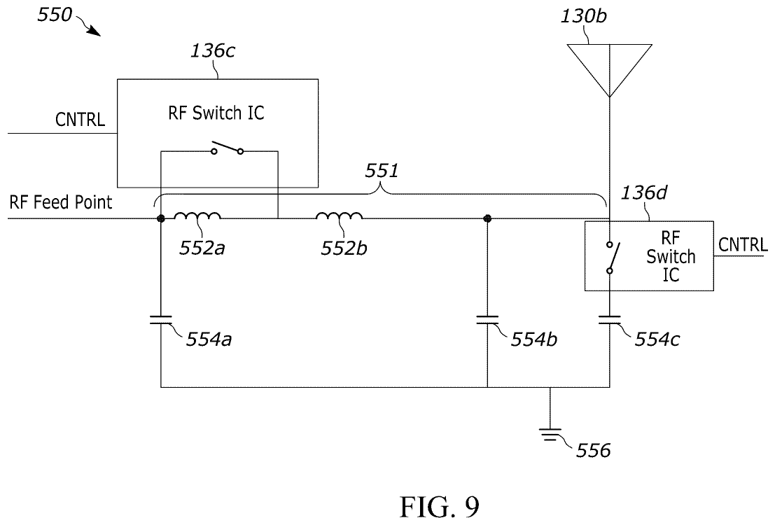

FIG. 9 is a diagram 550 illustrating the processing steps of FIG. 6. As shown in FIG. 9, a circuit 551 includes inductors 552a and 552b, capacitors 554a, 554b, and 554c, and a ground 556. The circuit 551 is coupled to an antenna 130b, a switch 136c, and a switch 136d. Each of the switches 136c and 136d includes a first position (e.g., when the switch is open) and a second position (e.g., when the switch is closed). The switch 136c and the switch 136d are SPST RF switches. In response to determining the operating mode of the device 100 is the first mode, each of the switches 136c and 136d may receive a control (CNTRL) signal from the controller 122 of the device 100 to activate the switches 136c and 136d to the first position (e.g., the open position) to exclude a tuning component (e.g., capacitor 554c of the circuit 551) and include a tuning component (e.g., inductor 552a of the circuit 551) to drive a first impedance of the antenna 130b associated with the first mode to the target impedance to operate the antenna 130b at the predetermined power level in a first frequency bandwidth and the predetermined range. Alternatively, in response to determining the operating mode of the device 100 is the second mode, each of the switches 136c and 136d may receive a control (CNTRL) signal from the controller 122 to activate the switches 136c and 136d to the second position (e.g., the closed position) to include the previously excluded tuning component (e.g., capacitor 554c of the circuit 551) and exclude the previously included tuning component (e.g., inductor 552a of the circuit 551) to drive a second impedance of the antenna 130b associated with the second mode and different from the first impedance to the target impedance to operate the antenna 130b at the predetermined power level in the first frequency bandwidth and the predetermined range. In this way, the controller 122 activates the switches 136c and 136d to maintain an impedance and frequency tuning of the antenna element 130b during different operating modes of the device 100 without necessitating an increase in power to the antenna 130b. In particular, the first position (e.g., the open position) accounts for when an external load is not applied to the antenna 130b in the first mode (e.g., a presentation operating mode) and the second position (e.g., the closed position) accounts for when an external load is applied to the antenna 130b in the second mode (e.g., a handheld operating mode). In a variation of the embodiment, the first position (e.g., the open position) accounts for when an external load is applied to the antenna element 130b in the first mode (e.g., a handheld operating mode) and the second position (e.g., the closed position) accounts for when an external load is not applied to the antenna element 130b in the second mode (e.g., a presentation operating mode).

In another variation of the embodiment, in response to determining the operating mode of the device 100 is the first mode, each of the switches 136c and 136d may receive a control (CNTRL) signal from the controller 122 of the device 100 to activate the switch 136c to the first position (e.g., the open position) to include a tuning component (e.g., inductor 552a of the circuit 551) and activate the switch 136d to the second position (e.g., the closed position) to include a tuning component (e.g., capacitor 554c of the circuit 551). In response to determining the operating mode of the device is the second mode, each of the switches 136c and 136d may receive a control (CNTRL) signal from the controller 122 of the device 100 to activate the switch 136c to the second position (e.g., the closed position) to exclude a tuning component (e.g., inductor 552a of the circuit 551) and activate the switch 136d to the second position (e.g., the open position) to exclude a tuning component (e.g., capacitor 554c of the circuit 551).

Alternatively, in another variation of the embodiment, in response to determining the operating mode of the device 100 is the first mode, each of the switches 136c and 136d may receive a control (CNTRL) signal from the controller 122 of the device 100 to activate the switch 136c to the second position (e.g., the closed position) to exclude a tuning component (e.g., inductor 552a of the circuit 551) and activate the switch 136d to the first position (e.g., the open position) to exclude a tuning component (e.g., capacitor 554c of the circuit 551). In response to determining the operating mode of the device is the second mode, each of the switches 136c and 136d may receive a control (CNTRL) signal from the controller 122 of the device 100 to activate the switch 136c to the first position (e.g., the open position) to include a tuning component (e.g., inductor 552a of the circuit 551) and activate the switch 136d to the second position (e.g., the closed position) to include a tuning component (e.g., capacitor 554c of the circuit 551).

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method for dynamically tuning an antenna, comprising:
determining an operating mode of a device from a first mode indicative of a presentation mode and a second mode indicative of a handheld mode, the device comprising an antenna having a target impedance that matches an impedance of a transceiver coupled to the antenna to provide maximum power transfer to the antenna and operate the antenna at a predetermined power level and a predetermined range, the target impedance changing based on the operating mode of the device;
responsive to determining the operating mode of the device is the first mode, utilizing a first circuit to drive a first impedance of the antenna associated with the first mode to the target impedance to operate the antenna at the predetermined power level in a first frequency bandwidth and the predetermined range; and
responsive to determining the operating mode of the device is the second mode, utilizing a second circuit to drive a second impedance of the antenna associated with the second mode and different from the first impedance to the target impedance to operate the antenna at the predetermined power level in the first frequency bandwidth and the predetermined range.

2. The method of claim 1, wherein
the device is a radio frequency identification (RFID) reader;
the first mode is indicative of a fixed state of the RFID reader;
the second mode is indicative of a mobile state of the RFID reader;
the antenna is a RFID antenna; and
the first and second circuits are matching networks comprised of inductors and capacitors.

3. The method of claim 1, wherein determining the operating mode of the device from the first mode indicative of the presentation mode and the second mode indicative of the handheld mode comprises:
determining whether an external load is applied to the antenna;
responsive to determining the external load is not applied to the antenna, determining the operating mode of the device is the first mode; and
responsive to determining the external load is applied to the antenna, determining the operating mode of the device is the second mode.

4. The method of claim 1, wherein determining the operating mode of the device from the first mode indicative of the presentation mode and the second mode indicative of the handheld mode comprises:
detecting, by a sensor, a state of the device from a fixed state and a mobile state, the device being positioned in a cradle in the fixed state and being held by a user in the mobile state;
responsive to detecting the fixed state, determining the operating mode of the device is the first mode; and
responsive to detecting the mobile state, determining the operating mode of the device is the second mode,
wherein the sensor is one of an accelerometer, a reed switch, a hall effect sensor, a capacitive touch sensor, an optical sensor, or a gyroscope.

5. The method of claim 1, wherein determining the operating mode of the device from the first mode indicative of the presentation mode and the second mode indicative of the handheld mode comprises:
detecting, by a sensor, a state of the device from a fixed state and a mobile state, the device being positioned in a cradle in the fixed state and being held by a user in the mobile state;
responsive to detecting the fixed state, determining the operating mode of the device is the first mode;
responsive to detecting the mobile state, determining whether an external load is applied to the antenna;
responsive to determining the external load is not applied to the antenna, determining the operating mode of the device is the first mode; and
responsive to determining the external load is applied to the antenna, determining the operating mode of the device is the second mode,
wherein the sensor is one of an accelerometer, a reed switch, a hall effect sensor, a capacitive touch sensor, an optical sensor, or a gyroscope.

6. The method of claim 1, further comprising:
responsive to determining the operating mode of the device is the first mode, utilizing the first circuit to drive the first impedance of the antenna associated with the first mode to the target impedance to operate the antenna at the predetermined power level in the first frequency bandwidth and the predetermined range.

7. A device, comprising:
an antenna, the antenna having a target impedance that matches an impedance of a transceiver coupled to the antenna to provide maximum power transfer to the antenna and operate the antenna at a predetermined power level and a predetermined range, the target impedance changing based on an operating mode of the device; and
a controller configured to
determine the operating mode of the device from a first mode indicative of a presentation mode and a second mode indicative of a handheld mode;
responsive to determining the operating mode of the device is the first mode, control a first circuit to drive a first impedance of the antenna associated with the first mode to the target impedance to operate the antenna at the predetermined power level in a first frequency bandwidth and the predetermined range; and
responsive to determining the operating mode of the device is the second mode, control a second circuit to drive a second impedance of the antenna associated with the second mode and different from the first impedance to the target impedance to operate the antenna at the predetermined power level in the first frequency bandwidth and the predetermined range.

8. The device of claim 7, wherein
the device is a radio frequency identification (RFID) reader;
the first mode is indicative of a fixed state of the RFID reader;
the second mode is indicative of a mobile state of the RFID reader;
the antenna is a RFID antenna; and
the first and second circuits are matching networks comprised of inductors and capacitors.

9. The device of claim 7, wherein the controller is configured to determine the operating mode of the device from the first mode indicative of the presentation mode and the second mode indicative of the handheld mode by
determining whether an external loading is applied to the antenna;
responsive to determining the external loading is not applied to the antenna, determine the operating mode of the device is the first mode; and
responsive to determining the external loading is applied to the antenna, determine the operating mode of the device is the second mode.

10. The device of claim 7, wherein the controller is configured to determine the operating mode of the device from the first mode indicative of the presentation mode and the second mode indicative of the handheld mode by
detecting, by a sensor, a state of the device from a fixed state and a mobile state, the device being positioned in a cradle in the fixed state and being held by a user in the mobile state;
responsive to detecting the fixed state, determining the operating mode of the device is the first mode; and
responsive to detecting the mobile state, determining the operating mode of the device is the second mode,
wherein the sensor is one of an accelerometer, a reed switch, a hall effect sensor, a capacitive touch sensor, an optical sensor, or a gyroscope.

11. The device of claim 7, wherein the controller is configured to determine the operating mode of the device from the first mode indicative of the presentation mode and the second mode indicative of the handheld mode by
detecting, by a sensor, a state of the device from a fixed state and a mobile state, the device being positioned in a cradle in the fixed state and being held by a user in the mobile state;
responsive to detecting the fixed state, determining the operating mode of the device is the first mode;
responsive to detecting the mobile state, determining whether an external load is applied to the antenna;
responsive to determining the external load is not applied to the antenna, determining the operating mode of the device is the first mode; and
responsive to determining the external load is applied to the antenna, determining the operating mode of the device is the second mode,
wherein the sensor is one of an accelerometer, a reed switch, a hall effect sensor, a capacitive touch sensor, an optical sensor, or a gyroscope.

12. The device of claim 7, wherein the controller is further configured to:
responsive to determining the operating mode of the device is the first mode, control the first circuit to drive the first impedance of the antenna associated with the first mode to the target impedance to operate the antenna at the predetermined power level in the first frequency bandwidth and the predetermined range.

13. A system for dynamically tuning an antenna, comprising:
an antenna, the antenna having a target impedance that matches an impedance of a transceiver coupled to the antenna to provide maximum power transfer to the antenna and operate the antenna at a predetermined power level and a predetermined range, the target impedance changing based on an operating mode of the device;
a first switch;
a second switch; and
a controller configured to
determine an operating mode of the device from a first mode indicative of a presentation mode and a second mode indicative of a handheld mode;
responsive to determining the operating mode of the device is the first mode, activate the first and second switches to a first position to control a first circuit to drive a first impedance of the antenna associated with the first mode to the target impedance to operate the antenna at the predetermined power level in a first frequency bandwidth and the predetermined range; and
responsive to determining the operating mode of the device is the second mode, activate the first and second switches to a second position to control a second circuit to drive a second impedance of the antenna associated with the second mode and different from the first impedance to the target impedance to operate the antenna at the predetermined power level in the first frequency bandwidth and the predetermined range.

14. The system of claim 13, wherein
the device is a radio frequency identification (RFID) reader;
the first mode is indicative of a fixed state of the RFID reader;
the second mode is indicative of a mobile state of the RFID reader;
the antenna is a RFID antenna; and
the first and second circuits are matching networks comprised of inductors and capacitors.

15. The system of claim 13, wherein the controller is configured to determine the operating mode of the device from the first mode indicative of the presentation mode and second mode indicative of the handheld mode by
determining whether an external load is applied to the antenna;
responsive to determining the external load is not applied to the antenna, determine the operating mode of the device is the first mode; and
responsive to determining the external load is applied to the antenna, determine the operating mode of the device is the second mode.

16. The system of claim 13, wherein the controller is configured to determine the operating mode of the device from the first mode indicative of the presentation mode and second mode indicative of the handheld mode by
detecting, by a sensor, a state of the device from a fixed state and a mobile state, the device being positioned in a cradle in the fixed state and being held by a user in the mobile state;
responsive to detecting the fixed state, determining the operating mode of the device is the first mode; and
responsive to detecting the mobile state, determining the operating mode of the device is the second mode,
wherein the sensor is one of an accelerometer, a reed switch, a hall effect sensor, a capacitive touch sensor, an optical sensor, or a gyroscope.

17. The system of claim 13, wherein the controller is configured to determine the operating mode of the device from the first mode indicative of the presentation mode and second mode indicative of the handheld mode by
detecting, by a sensor, a state of the device from a fixed state and a mobile state, the device being positioned in a cradle in the fixed state and being held by a user in the mobile state;
responsive to detecting the fixed state, determining the operating mode of the device is the first mode;
responsive to detecting the mobile state, determining whether an external load is applied to the antenna;
responsive to determining the external load is not applied to the antenna, determining the operating mode of the device is the first mode; and
responsive to determining the external load is applied to the antenna, determining the operating mode of the device is the second mode,
wherein the sensor is one of an accelerometer, a reed switch, a hall effect sensor, a capacitive touch sensor, an optical sensor, or a gyroscope.

18. The system of claim 13, wherein the controller is further configured to:
responsive to determining the operating mode of the device is the first mode, activate the first and second switches to the first position to control the first circuit to drive the first impedance of the antenna associated with the first mode to the target impedance to operate the antenna at the predetermined power level in the first frequency bandwidth and the predetermined range.

19. The system of claim 13, wherein the controller is further configured to:
select a first radio frequency (RF) path in response to determining the operating mode of the device is the first mode;
activate the first and second switches to the first position to control the first circuit to drive the first impedance of the antenna associated with the first mode to the target impedance to operate the antenna at the predetermined power level in the first frequency bandwidth and the predetermined range, the first position being associated with the first RF path;
select a second RF path in response to determining the operating mode of the device is the second mode; and
activate the first and second switches to the second position to control the second circuit to drive the second impedance of the antenna associated with the second mode and different from the first impedance to the target impedance to operate the antenna at the predetermined power level in the first frequency bandwidth and the predetermined range, the second position being associated with the second RF path.

20. A system for dynamically tuning an antenna, comprising:
an antenna, the antenna having a target impedance that matches an impedance of a transceiver coupled to the antenna to provide maximum power transfer to the antenna and operate the antenna at a predetermined power level and a predetermined range, the target impedance changing based on an operating mode of the device;
at least one tuning component;
at least one switch; and
a controller configured to
determine an operating mode of the device from a first mode indicative of a presentation mode and a second mode indicative of a handheld mode;
responsive to determining the operating mode of the device is the first mode, activate the at least one switch to a first position to exclude the at least one tuning component and/or include the at least one tuning component to drive a first impedance of the antenna associated with the first mode to the target impedance to operate the antenna at the predetermined power level in a first frequency bandwidth and the predetermined range; and
responsive to determining the operating mode of the device is the second mode, activate the at least one switch to a second position to include the previously excluded at least one tuning component and/or exclude the previously excluded at least one tuning component to drive a second impedance of the antenna associated with the second mode and different from the first impedance to the target impedance to operate the antenna at the predetermined power level in the first frequency bandwidth and the predetermined range.
